(19) United States
(12) Patent Application Publication
(10) Pub. No.: US 2025/0245449 A1
(43) Pub. Date: Jul. 31, 2025

(54) SYSTEMS AND METHODS OF AUTOMATED GENERATION OF THEME-AWARE KEYWORDS FOR AN ITEM

(71) Applicant: Walmart Apollo, LLC, Bentonville, AR (US)

(72) Inventors: Reza Yousefi Maragheh, Los Altos, CA (US); Chenhao Fang, San Jose, CA (US); Charan Chand Irugu, Milpitas, CA (US); Parth Hetal Parikh, Sunnyvale, CA (US); Jianpeng Xu, Cupertino, CA (US); Malay Kumar Patel, Fremont, CA (US); Saranyan Sukumar, Pleasanton, CA (US); Hyun Duk Cho, San Francisco, CA (US); Sushant Kumar, San Jose, CA (US); Evren Korpeoglu, San Jose, CA (US); Kannan Achan, Saratoga, CA (US)

(21) Appl. No.: 19/027,645

(22) Filed: Jan. 17, 2025

Related U.S. Application Data
(60) Provisional application No. 63/627,247, filed on Jan. 31, 2024.

(51) Int. Cl. G06F 40/40

(52) U.S. Cl. CPC G06F 40/40

(57) ABSTRACT

Example implementations relate to generating keywords. An item data structure including textual information is received. A first context associated with the textual information is determined and a plurality of keywords is generated using a first trained model that receives the textual information and the first context. A plurality of matching item data structures including respective textual information corresponding to a plurality of matching items associated with the item is received. A set of reference keywords is generated using a second trained model that receives the respective textual information and one or more of second contexts. A relevancy score is determined between at least one keyword and the first context using the first trained model, and an interface that includes the at least one keyword is generated.

### CROSS-REFERENCE TO RELATED APPLICATIONS

This application claims priority to U.S. Provisional Patent Application No. 63/627,247, filed Jan. 31, 2024, entitled “Systems and Methods of Automated Generation of Theme-Aware Keywords for an Item,” which is incorporated by reference herein in its entirety.

### TECHNICAL FIELD

This application relates generally to automated generation of keywords for an item, and more particularly, to automated generation of summary abstractive keywords for an item in a network environment.

### BACKGROUND

An item listed in a network environment may include an associated textual description for the item. In the absence of keywords summarizing the textual description, a user may have to spend time parsing the textual description to determine whether the item is of interest. Manual generation of keywords that summarize the textual description is burdensome and time consuming. The absence of summary keywords may reduce user engagement, and may not be able to quickly provide information that is pertinent to a user's specific interests.

### BRIEF DESCRIPTION OF THE DRAWINGS

Various examples will be described by the following detailed description, which is to be considered together with the accompanying drawings wherein like numbers refer to like parts and further wherein:

FIG. 1 illustrates a network environment that provides automated keyword and interface generation, in accordance with some embodiments;

FIG. 2A illustrates a computer system that implements one or more processes, in accordance with some embodiments;

FIG. 2B illustrates a network environment that provides keywords, in accordance with some embodiments;

FIG. 3A is a flowchart illustrating a method of generating an interface including an item having keywords, in accordance with some embodiments;

FIG. 3B is a flowchart illustrating a keyword generation method, in accordance with some embodiments;

FIG. 4A is a process flow illustrating various steps of the interface generation method of FIG. 3A, in accordance with some embodiments;

FIG. 4B is a process flow illustrating various steps of the keyword generation method of FIG. 3B, in accordance with some embodiments;

FIG. 5A illustrates an example user interface, in accordance with some embodiments;

FIG. 5B illustrates an example process flow of a keyword generation method, in accordance with some embodiments;

FIG. 6A and FIG. 6B illustrate example post-processing modules used to generate keywords, in accordance with some embodiments;

FIG. 7 illustrates an artificial neural network, in accordance with some embodiment; and

FIG. 8 illustrates a deep neural network (DNN), in accordance with some embodiments; and

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the example embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for generating keywords. In various embodiments, an item data structure including textual information about an item is received. A context associated with the textual information is determined (e.g., derived) and a plurality of keywords is generated by providing the textual information and the first context to a first trained model. A set of reference keywords is generated by providing the respective textual information to a second trained model. The at least one keyword is compared with the set of reference keywords. In accordance with a determination that the set of reference keywords includes at least one keyword, a relevancy score is determined between the at least one keyword and the first context using the first trained model, and in accordance with a determination that the relevancy score exceeds a first threshold; an interface that includes the at least one keyword in the plurality of keywords is generated.

In various embodiments, a system is disclosed. The system includes a non-transitory memory and a processor communicatively coupled to the non-transitory memory. The processor receives an item data structure including textual information about an item; determine information about a context associated with the textual information; generate a plurality of keywords by providing the textual information and the first context to a first trained model; receive a plurality of matching item data structures including respective textual information corresponding to a plurality of matching items associated with the item; determine respective contexts associated with the respective textual information; generate a set of reference keywords using a second trained model that receives the respective textual information and one of the one or more second contexts. In accordance with a determination that the set of reference keywords includes at least one keyword: determine a relevancy score between the at least one keyword and the first context using the first trained model; and in accordance with a determination that the relevancy score exceeds a first threshold; generate an interface that includes the at least one keyword in the plurality of keywords.

In various embodiments, a computer-implemented method is disclosed. The computer-implemented method includes steps of receiving an item data structure including textual information about an item; determining information about a context associated with the textual information; generating a plurality of keywords by providing the textual information and the first context to a first trained model; receiving a plurality of matching item data structures including respective textual information corresponding to a plurality of matching items associated with the item; determining respective contexts associated with the respective textual information; generating a set of reference keywords by using a second trained model that receives the respective textual information and the one of the one or more second contexts, and comparing the at least one keyword with the set of reference keywords. In accordance with a determination that the set of reference keywords includes at least one keyword: the computer-implemented method includes steps of determining a relevancy score between the at least one keyword and the first context using the first trained model; and in accordance with a determination that the relevancy score exceeds a first threshold; the computer-implemented method includes the step of generating an interface that includes the at least one keyword in the plurality of keywords.

In various embodiments, a non-transitory computer readable medium having instructions stored thereon is disclosed. The instructions, when executed by at least one processor, cause at least one device to perform operations including receiving an item data structure including textual information about an item; determining information about a context associated with the textual information; generating a plurality of keywords by providing the textual information and the first context to a first trained model; receiving a plurality of matching item data structures including respective textual information corresponding to a plurality of matching items associated with the item; determining respective contexts associated with the respective textual information; generating a set of reference keywords by providing the respective textual information and the respective context to a second trained model. In accordance with a determination that the set of reference keywords includes the at least one keyword: the instructions, when executed by the at least one processor, cause the at least one device to perform operations including determining a relevancy score between the at least one keyword and the first context using the first trained model; and in accordance with a determination that the at least one keyword meets first criteria that include the relevancy score exceeding a first threshold; the instructions, when executed by the at least one processor, cause the at least one device to perform operations including the step of generating an interface that includes the at least one keyword.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In some embodiments, a trained function may include a neural network, a support vector machine, a decision tree, a Bayesian network, k-means clustering network, Qlearning, genetic algorithms and/or association rules, and/or any other suitable artificial intelligence architecture. In some embodiments, a neural network can be a deep neural network, a convolutional neural network, a convolutional deep neural network, etc. Furthermore, a neural network can be an adversarial network, a deep adversarial network, a generative adversarial network, etc.

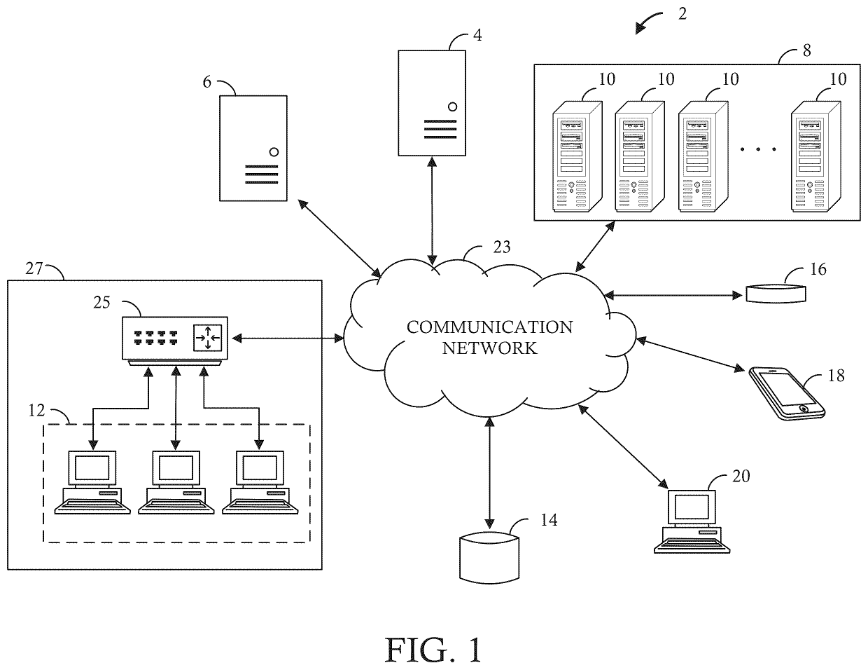

FIG. 1 illustrates a network environment 2 that provides automated keyword and interface generation, in accordance with some embodiments. The network environment 2 includes a plurality of devices or systems that communicates over one or more network channels, illustrated as a network cloud 23. For example, in various embodiments, the network environment 2 may include, but is not limited to, a keyword and interface generation computing device 4, a web server 6, a cloud-based engine 8 including one or more processing devices 10, workstation(s) 12, a database 14, and/or one or more user computing devices 16, 18, 20 operatively coupled over the network 23. The keyword and interface generation computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 23.

In some embodiments, each of the keyword and interface generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the keyword and interface generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment or a keyword and interface generation environment. In some embodiments, the keyword and interface generation computing device 4, the processing devices 10, and/or the web server 6 are operated by the network environment provider, and workstation(s) 12 and/or the user computing devices 16, 18, 20 are operated by users of the network environment. In some embodiments, the processing devices 10 are operated by a third party (e.g., a cloud-computing provider).

The workstation(s) 12 are operably coupled to the communication network 23 via a router (or switch) 25. The workstation(s) 12 and/or the router 25 may be located at a physical location 27 remote from the keyword and interface generation computing device 4, for example. The workstation(s) 12 may communicate with the keyword and interface generation computing device 4 over the communication network 23. The workstation(s) 12 may send data to, and receive data from, the keyword and interface generation computing device 4. For example, the workstation(s) 12 may transmit data related to user interface element packages selected for keyword and interface generation, for example, user interface element package data structures.

Although FIG. 1 illustrates three user computing devices 16, 18, 20, the network environment 2 may include any number of user computing devices 16, 18, 20. Similarly, the network environment 2 may include any number of the keyword and interface generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the keyword and interface generation computing device 4, the web server 6, the workstation(s) 12, the database 14, the user computing devices 16, 18, 20, and/or the router 25 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 23 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 23 may provide access to, for example, the Internet.

Each of the user computing devices 16, 18, and 20 may communicate with the web server 6 over the communication network 23. For example, each of the user computing devices 16, 18, 20 may be operable to view, access, and interact with a website, such as a keyword and interface generation website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the keyword and interface generation computing device 4 over the communication network 23. The website may also allow the user to interact with one or more of interface elements to perform specific operations, such as selecting one or more items for further processing. In some embodiments, the web server 6 transmits user interaction data identifying interactions between the user and the website to the keyword and interface generation computing device 4.

In some embodiments, the keyword and interface generation computing device 4 may execute one or more models, processes, or algorithms, such as a machine learning model, deep learning model, statistical model, etc., to generate keywords that correspond to an item. The keyword and interface generation computing device 4 may receive a keyword and interface generation request from the web server 6 over the communication network 23. For example, the web server 6 may display interface elements associated with a characteristics selection interface that receives identification of features, constraints, characteristics and/or other inputs to allow generation of keywords by the keyword and interface generation computing device.

The keyword and interface generation computing device 4 is further operable to communicate with the database 14 over the communication network 23. For example, the keyword and interface generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the keyword and interface generation computing device 4, in some embodiments, the database 14 may be a local storage device, such as a hard drive, a non-volatile memory, or a USB stick. The keyword and interface generation computing device 4 may store interaction data received from the web server 6 in the database 14. The keyword and interface generation computing device 4 may also receive from the web server 6 user session data identifying events associated with browsing sessions, and may store the user session data in the database 14.

The models, when executed by the keyword and interface generation computing device 4, allow the keyword and interface generation computing device 4 to generate keywords for an item. For example, the keyword and interface generation computing device 4 may obtain one or more models from the database 14. The keyword and interface generation computing device 4 may then receive, in real-time from the web server 6, a keyword and interface generation request. In response to receiving the keyword and interface generation request, the keyword and interface generation computing device 4 may execute one or more models to generate keywords.

In some embodiments, the keyword and interface generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, keyword and interface generation computing device 4 may generate keywords that can be integrated into a user interface associated with an item.

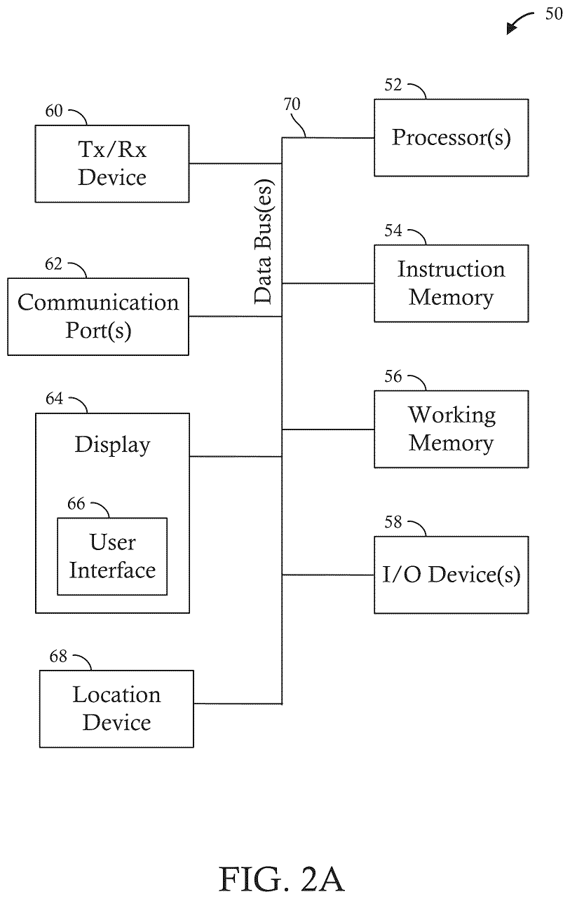

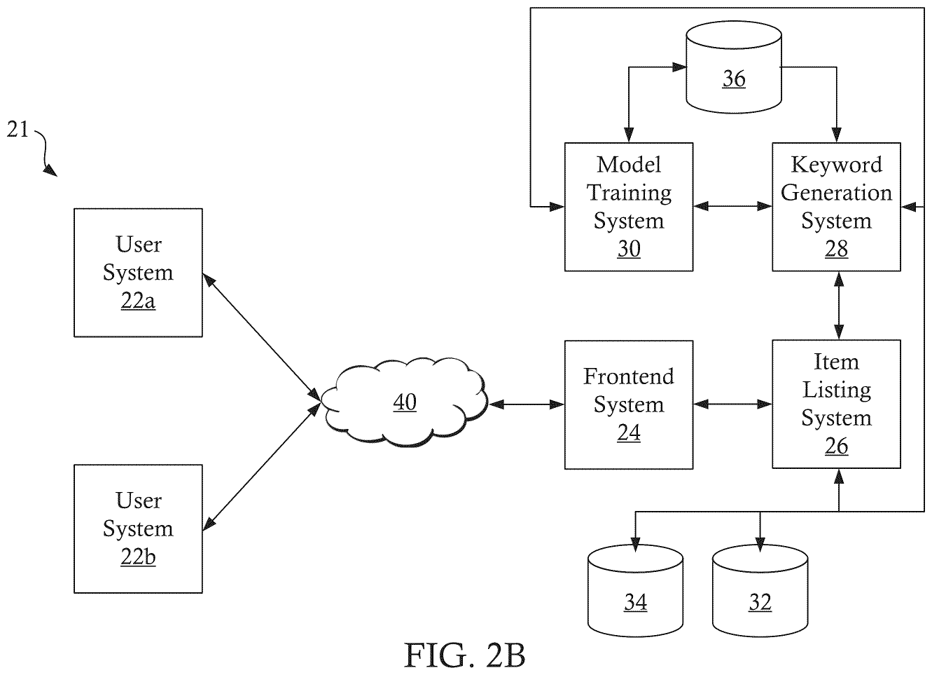

FIG. 2A illustrates a block diagram of a computing device 50, in accordance with some embodiments. In some embodiments, each of the keyword and interface generation computing device 4, the web server 6, the one or more processing devices 10, the workstation(s) 12, and/or the user computing devices 16, 18, 20 in FIG. 1 may include the features shown in FIG. 2A. Although FIG. 2A is described with respect to certain components shown therein, it will be appreciated that the elements of the computing device 50 may be combined, omitted, and/or replicated. In addition, it will be appreciated that additional elements other than those illustrated in FIG. 2A may be added to the computing device.

As shown in FIG. 2A, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 perform a certain function or operation by executing code, stored on the instruction memory 54, embodying the function or operation. For example, the one or more processors 52 may execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit that operates as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for automated keyword and interface generation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 23 of FIG. 1. For example, if the communication network 23 of FIG. 1 is a cellular network, the transceiver 60 allows communications with the cellular network. In some embodiments, the transceiver 60 is selected based on the type of the communication network 23 the computing device 50 will be operating in. The one or more processors 52 are operable to receive data from, or send data to, a network, such as the communication network 23 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with automated keyword and interface generation. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device that receives position data identifying a latitude and longitude from one or more satellites of a GPS constellation. As another example, in some embodiments, the location device 68 is a cellular device that receives location data from one or more localized cellular towers. Based on the position data, the computing device 50 may determine a local geographical area (e.g., town, city, state, etc.) of its position.

In some embodiments, the computing device 50 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

FIG. 2B illustrates a network environment 21 that provides an interface including keywords, in accordance with some embodiments. The network environment 21 includes a plurality of systems that communicates over one or more network channels, illustrated as network cloud 40. For example, in various embodiments, the network environment 21 can include, but is not limited to, one or more user systems 22a, 22b, a frontend system 24, an item listing system 26, a keyword and interface generation system 28, a model training system 30, an item database 32, a keyword database 34, a model store database 36, and/or any other suitable systems. It will be appreciated that any of the illustrated systems can include a system as described above in conjunction with FIGS. 1 and 2A. Although specific embodiments are discussed, herein it will be appreciated that additional systems, servers, storage mechanism, etc. can be included within the network environment 21.

Further, although embodiments are illustrated herein having individual, discrete systems, it will be appreciated that, in some embodiments, one or more systems can be combined into a single logical and/or physical system. For example, in various embodiments, the frontend system 24, the item listing system 26, the keyword and interface generation system 28, the model training system 30, the item database 32, the keyword database 34, and/or the model store database 36 can be combined into a single logical and/or physical system. Similarly, although embodiments are illustrated having a single instance of each system, it will be appreciated that additional instances of a system can be implemented within the network environment 21. In some embodiments, two or more systems can be operated on shared hardware in which each system operates as a separate, discrete system utilizing the shared hardware, for example, according to one or more virtualization schemes.

In some embodiments, the user systems 22a, 22b are operable by one or more users to access a network interface provided by the frontend system 24. The network interface can include any suitable interface, such as, for example, a web or internet-based interface that provides one or more interface pages (e.g., webpages) for user interaction. Examples of network interfaces can include, but are not limited to, e-commerce interfaces, service interfaces, and/or any other suitable network interface. The frontend system 24 can provide any suitable resources required for generation and operation of the network interface, such as, for example, one or more components of a server.

In some embodiments, the frontend system 24 includes an interface generation engine that provides a network interface, such as a webpage, that allows an operator of a user system 22a, 22b to add additional items to the item database. For example, in some embodiments, the frontend system 24 generates an interface for receiving item data from a user system 22a, 22b. The item data can include item names, titles, descriptions, images, and/or any other suitable data associated with an item. In some embodiments, the item data is provided to an item listing system 26 that generates an item record for the uploaded item in a database, such as the item database 32, that adds the item represented by the item data to a catalog of items presented through a second interface, such an e-commerce interface.

In some embodiments, the frontend system 24 generates an interface including an item having keywords. For example, a user system 22a can request an interface including an item selected from a catalog, such as a search interface including search results selected from an item catalog related to a search query. The frontend system 24 generates an interface including item data for the item selected form the item catalog. The user interface displaying the selected item includes keywords, as discussed herein.

In some embodiments, a keyword and interface generation system 28 generates keywords for items that are being added to a catalog via the item listing system 26 and/or items stored in the item database 32. The keyword and interface generation system 28 can automatically provide summarized keywords for the newly listed item.

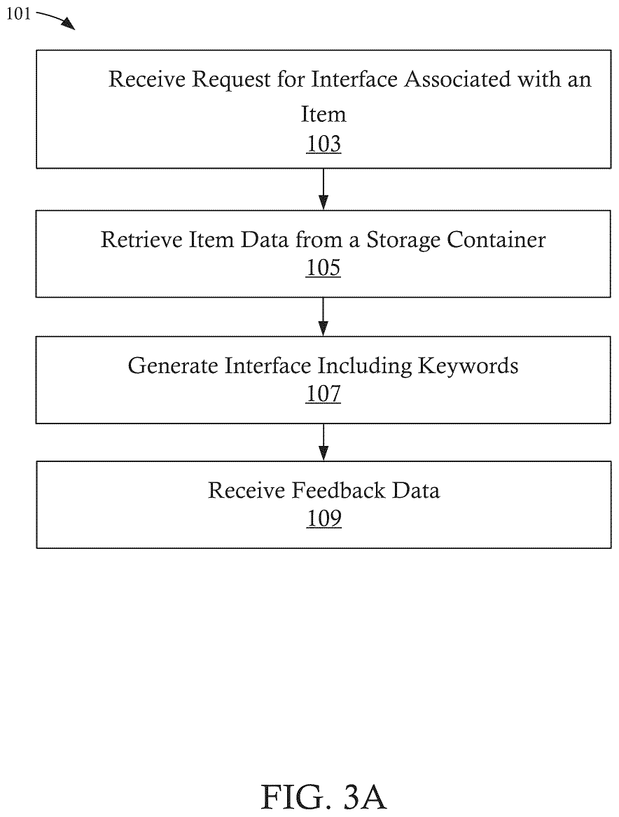

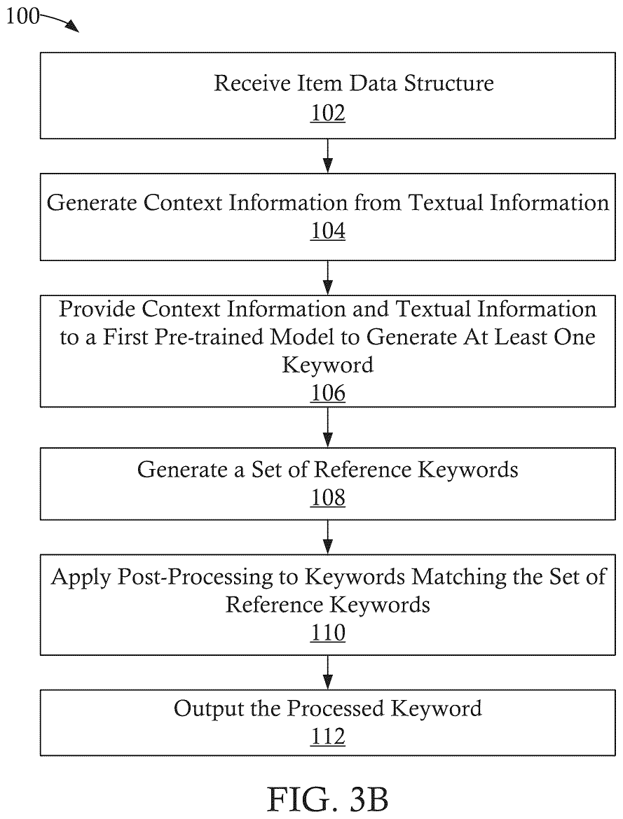

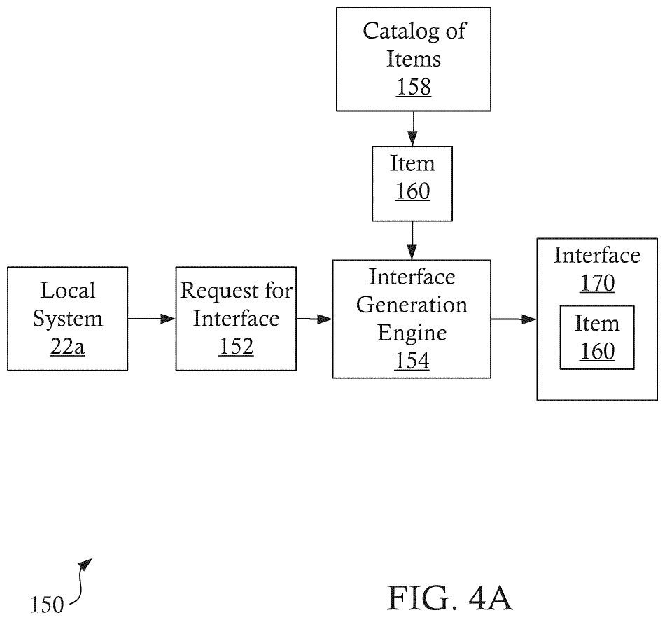

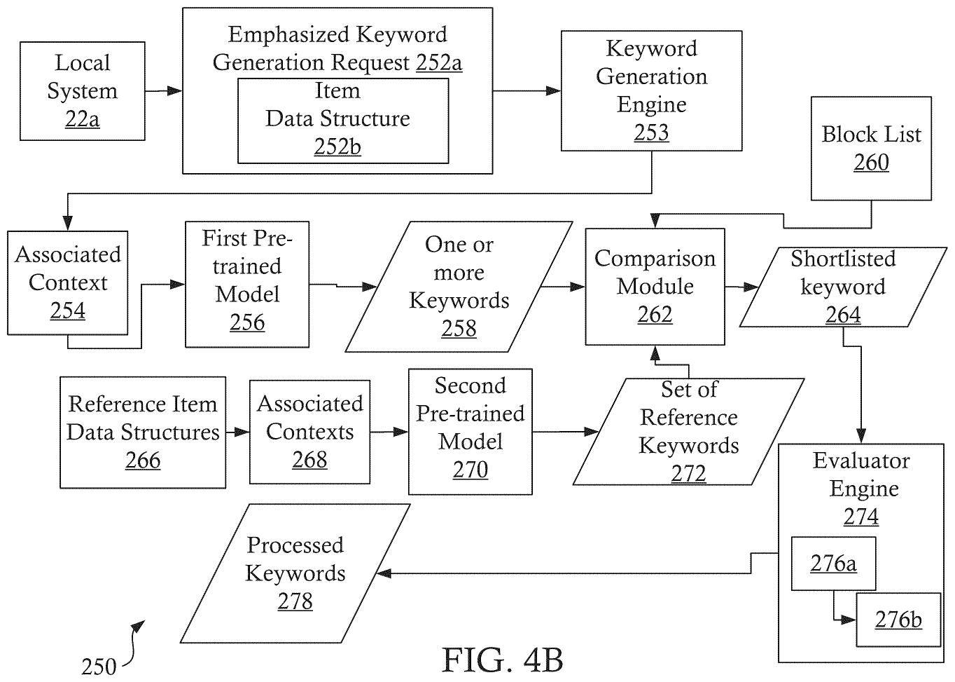

FIG. 3A is a flowchart illustrating a method 101 of generating an interface that includes an item having keywords, in accordance with some embodiments. FIG. 4A is a process flow 150 illustrating various steps of the method 101 of generating an interface that includes an item having keywords, in accordance with some embodiments. At step 103, a request 152 for a user interface is received. The request can be generated by any suitable system, such as, for example, a user system 22a, 22b. The request 152 can be for any suitable network interface, such as, for example, a webpage, application interface, intranet interface, etc. In some embodiments, the request 152 can include identifiers, such as a system identifier and/or a user identifier, that associate the request 152 with a specific system, e.g., user system 22a, and/or a specific user.

In some embodiments, the requested interface includes items stored within a catalog associated with a network environment. For example, the requested interface can include an e-commerce interface and the request 152 can include a request for items stored in a product or item catalog associated with the e-commerce platform. In some embodiments, the request 152 can include a search query having one or more search terms defining the set of requested items. In some embodiments, the request 152 can include a request for a webpage including a set of containers that displays items selected from a catalog associated with the interface, such as, for example, recommended items. Although specific embodiments are discussed herein, it will be appreciated that any suitable interface including one or more items selected from a catalog can be presented and are within the scope of this disclosure.

In some embodiments, the request 152 is received by an interface generation engine 154. The interface generation engine 154 receives the request 152 and generate an interface, as discussed in greater detail below. At step 105, item data is retrieved from a storage container. In some embodiments, the interface generation engine 154 obtains one or more template or default pages and populate the template with user-specific, search-specific, context-specific, and/or other customized content, including an item selected from a catalog of items 158 associated with the interface generation engine 154.

At step 107, an interface 170 is generated including the item 160 selected from the catalog of items 158. For example, in some embodiments, the request 152 includes a search query and the item 160 is the item that best matches the search query. As another example, in some embodiments, the request 152 includes a personalization identifier, such as a user identifier, and the item 160 is selected for display based on the personalization identifier. As yet another example, in some embodiments, the items 160 may be selected based on a context of the interface, such as a seasonal campaign, the item 160 may be related to specific portions of an interface, or the item 160 may be related to a user or interface context, etc. At step 109, feedback data is received after the interface is generated.

The item 160 may be displayed with keywords in the interface 170. As discussed in greater detail below, items added to the catalog of items 158 may not include keywords. Keywords that are generated (e.g., automatically generated) after an item is added to the catalog of items 158 may help a user review the information on interface 170 to more easily and quickly understand relevant aspects of the item 160, improving the user's experience within the network environment (e.g., ecommerce environment). For example, the user may be able to select a desired or relevant item more quickly and without having to parse and understand lengthier textual descriptions associated with the item 160. By incorporating one or more keywords (e.g., ranked keywords, etc.) in a content container of the interface 170, the interface 170 may be adapted to increase the relevance of the item information provided to the user via the interface 170.

The item 160 may be displayed in any suitable portion of the interface 170 at step 206. For example, when the request 152 includes a search query, the interface 170 can include a search result interface including the at least one item 160 within the displayed search results. As another example, the request 152 may include a request for an interface page associated with the item 160 from a search result interface that displays search results that includes the item 160. It will be appreciated that the item 160 can be incorporated into an interface 170 in any suitable location based on the layout of the interface 170 and/or the composition of the item 160.

The task of identifying relevant aspects of an item (e.g., the item 160) from the interface 170, which in some cases, may be displayed after a user has navigated expansive electronic catalogs of items to locate the item 160 (or other specific items of interest) can be burdensome and time consuming for users, especially if the user has yet to determine if the item (e.g., the item 160) satisfies specific criteria of interest relevant to the user. Typically, a user can gain a better understanding of the item 160 by reading item descriptions and/or item reviews (e.g., provided by other users). Such textual information is typically provided in lengthier prose and the relevance or the lack thereof may not be apparent to the user until the user has already spent time reading through the textual information. Thus, the user may frequently have to read through numerous textual descriptions of various item before the user can determine whether a particular item satisfies specific criteria of interest. In the absence of keywords (e.g., emphasize, highlighted or otherwise prominently displayed, etc.) in the interface 170, a user may have to review most of the textual information presented in the interface 170 to determine whether the item 160 satisfies specific criteria of interest relevant to the user.

The automatic generation of keywords (e.g., ranked keywords, etc.) in an interface (e.g., the interface 170) associated with the item (e.g., the item 160), as disclosed herein, significantly reduces this problem, allowing users to determine more quickly if the item satisfies specific criteria of interest relevant to the users and without the users having to parse through lengthier textual information. For example, in some embodiments described herein, when a user is presented with the interface 170 associated with the item 160, a content container in the interface 170 displays keywords associated with the item 160. Each keyword displayed in the content container may be extracted or abstracted from the textual description and/or item reviews associated with the item, allowing a user to bypass the lengthier textual information presented on interface 170. Beneficially, displaying the keywords shortens the time the user takes to determine if the item 160 meets specific criteria of interest relevant to the user, and provides a more efficient experience with the ecommerce environment (e.g., that allows a user to more quickly locate and select an item that meets specific criteria of interest), improving the speed of the user's navigation through an electronic interface.

FIG. 3B is a flowchart illustrating a keyword generation method 100, in accordance with some embodiments. FIG. 4B is a process flow 250 illustrating various steps of the keyword generation method 100, in accordance with some embodiments. At step 102, an item data structure 252b is received, together with a keyword and interface generation request 252a. The keyword and interface generation request 252a may be generated by any suitable system, such as, for example, an item listing system 26. The keyword and interface generation request 252a can be for any suitable network interface, such as, for example, a webpage, application interface, intranet interface, etc. In some embodiments, the keyword and interface generation request 252a can include identifiers, such as a system identifier and/or a user identifier, that associate the request 252 with a specific system, e.g., user system 22a, and/or a specific user. In some embodiments, the keyword and interface generation request 252a is automatically generated (e.g., by the local system 22a, etc.) in accordance with a determination that keywords associated with an item (e.g., the item 160) are not yet stored within a database of the ecommerce environment (e.g., without an active user input). The item data structure 252b includes textual information or textual metadata about the item 160. For example, the item title for the item 160 may be a type of textual metadata about the item 160. The textual information may be textual description supplied by a user who lists the item in the ecommerce environment (e.g., listing the item in a catalog of items 158 associated with the ecommerce environment) and/or determined (e.g., derived) from item reviews of the item 160 obtained from the user listing the item, or from other sources (e.g., from different network environments, etc.).

At step 104, context information about the item 160 is generated from the textual information or textual metadata, via a first pre-trained model 256, such as a large language model (LLM) 256 (e.g., one or more LLM such as GPT-3.5, GPT-4, LLAMA-2) that is in communication with a keyword generation engine 253 (e.g., via an API call, and/or is a part of the keyword generation engine 253). In some embodiments, the automatically generated keywords associated with the item 160 are both context-aware and theme-aware. In general, context is determined from the textual information. For example, an item may include in its data structure a textual description regarding how the item is to be installed, the LLM may extract context information that the item is installed using only one screw. For example, “requires only one screw to install” may be the first context that is extracted from the textual description of the item. From the first context, a theme may be determined. Using the same example as above, “easy installation” may be the theme that is determined based on the first context of “requires only one screw to install.” Other examples of themes that may be extracted from the first context includes “Christmas,” “adjustable”, “light weight,” etc.

At step 106, context information, such as the associated context 254, and the textual information from the item data structure 252b are provided to the first pre-trained model 256 to generate at least one keyword 258. In some embodiments, the at least one keyword 258 is generated through abstractive LLM engineered prompt calls. The prompt calls may include natural language text, formatted text, sets of descriptions, and/or any other suitable text format. For example, an abstractive prompt call may include instructions such as “you are an English-speaking e-commerce catalog specialist. You are an expert in generating summary keywords for a given item. Summarize the following item textual metadata in K short words. Here is the item textual metadata: <item_textual_metadata>.” In some embodiments, an extractive prompt call may be used. For example, an extractive prompt call may include instructions such as “you are an English-speaking e-commerce catalog specialist. You are an expert in generating summary keywords for a given item. Summarize the following item textual metadata in K short words where the exact word should exist in the text provided by a user. Here is the item textual metadata: <item_textual_metadata>. Do not output adjective which are not in the textual description.” In some embodiments, abstractive prompt calls may result in a more diverse set of keywords being generated compared to extractive prompt calls. In some embodiments, the abstractive or extractive prompt is generated individually (e.g., manually). In some embodiments, an automated process is used to generate abstractive or extractive prompts. In some embodiments, templates may be completed with specific information, such as item textual metadata, to generate the abstractive or extractive prompts.

In some embodiments, the first context information about the item 160 may not be separately provided to the first pre-trained model 256, but is extracted from the textual information (e.g., textual metadata, etc.) item data structure 252b by the first pre-trained model 256 during the process of generating the one or more keywords 258 from the item data structure 252b. The one or more keywords 258 may correspond to themes that are extracted from the first context, in the manner described above. For example, the theme is a word that is not included in the textual information but a word that the first pre-trained model 256 infers and abstracts from the associated context 254 and the textual information. An instruction template is also provided as an input to the first pre-trained model 256 to instruct the first pre-trained model 256 regarding the formatting and/or type of output (e.g., the format of themes or keywords 258) to be generated by the first pre-trained model 256.

At step 108, a set of reference keywords 272 is generated from reference item data structures 266 provided to a second pre-trained model 270. For example, when an item having the item data structure 252b is incorporated into a catalog associated with the network environment (e.g., a headphone, etc.), a list of reference items in the catalog that match the newly listed item (e.g., from the same type of item category, etc.) may be generated. For example, for an added headset, a catalog associated with the network environment may have a number (e.g., a large number, ten thousand, a hundred thousand, etc.) of headsets in its database, which may then be used as reference items for the added headset. From the data structures 266 of these reference items (e.g., all the headsets, a subset of the headsets, etc.), an associated context 268 (e.g., one or more second contexts) for each reference item is provided to a second pre-trained model 270. The second pre-trained model 270 may be a different pre-trained model from the first pre-trained model 256. For example, the second pre-trained model may be a model that requires fewer resources to run operations (e.g., inferences etc.) on, compared to the first pre-trained model. The second pre-trained model may be more easily scaled up compared to the first pre-trained model.

A block list 260 including words and/or terms that are not suitable to be keywords is provided to a comparison module 262. For example, terms that are common adjectives (e.g., “good,” “perfect,” “stylish,” etc.), terms with negative connotations (e.g., “flimsy,” “poor,” “unreliable,” etc.), inappropriate sensitive terms, etc. may not be suitable for use as keywords and may be included in the block list 260. By eliminating less informative (e.g., non-informative, etc.) and/or general keywords that do not convey sufficient information, the quality of the generated keywords or themes may be improved. The one or more keywords 258, and the set of reference keywords 272 may also be provided to the comparison module 262. The one or more keywords 258 that have a corresponding match within the set of reference keywords 272 may undergo further post-processing at step 110 as shortlisted keywords. For example, post-processing only those shortlisted keywords that have a corresponding match within the set of reference keywords 272 may reduce (e.g., eliminate, etc.) keywords generated by hallucinations via the first pre-trained model and/or improves the quality of the generated keywords by ensuring that they are more relevant and/or appropriate for the item having the item data structure 252b.

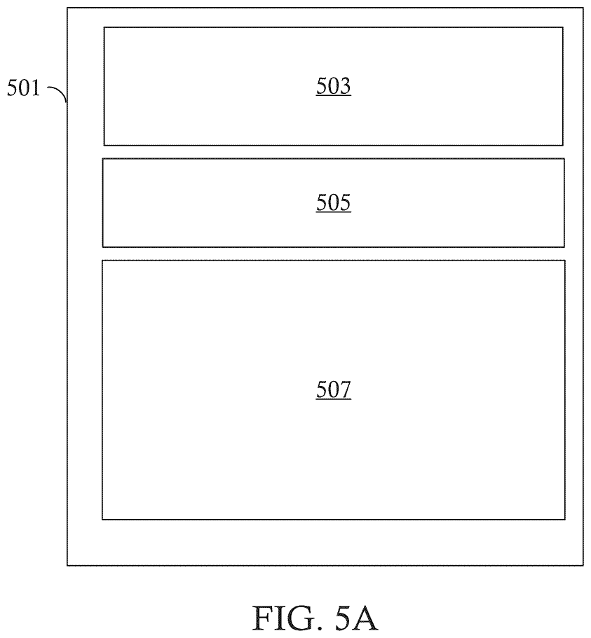

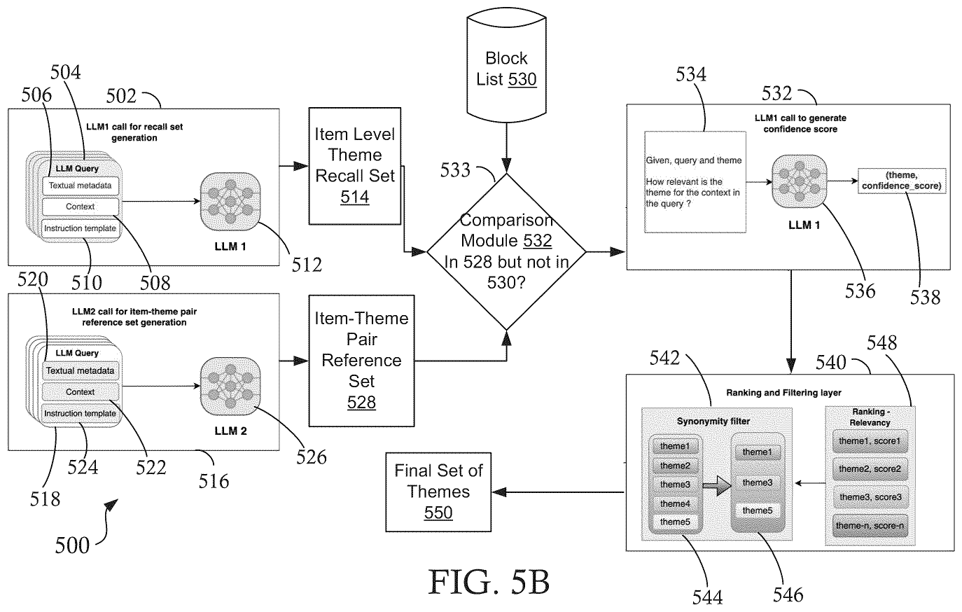

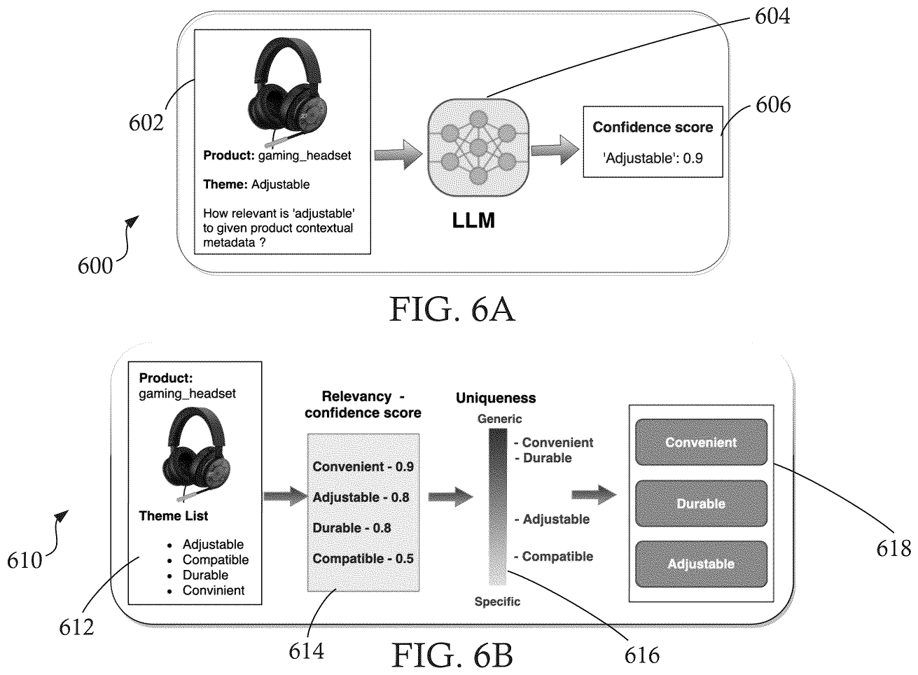

The shortlisted keywords may be provided to an evaluator engine 274. The evaluator engine 274 includes a confidence score generation module 276a and a ranking/filtering module 276b. At step 112, the evaluator engine 274 outputs keywords that have passed through the post-processing steps as processed keywords 278. Details regarding the confidence score generation module 276a and a ranking/filtering module 276b are discussed in greater detail below, in reference to FIGS. 5B, 6A, and 6B. After the keywords are generated, they are displayed in a portion of a user interface associated with the item. For example, the keywords are displayed as an ordered set of keywords are displayed in a content container of the user interface.

In some embodiments, one or more filtering and/or review processes may be implemented at various stages to identify and/or prevent generation of undesirable textual content. For example, one or more filtering processes may be applied to identify, remove, and/or otherwise eliminate undesirable content such as inappropriate texts, offensive texts, restricted texts, etc. Filtering may occur at any suitable stage of the keyword generation process, such as, for example, step 110, etc. Although specific embodiments are discussed herein, it will be appreciated that any suitable filtering may applied at any suitable steps of the disclosed methods.

FIG. 5A shows an example user interface associated with an item, in accordance with some embodiments. A user interface 501 includes a first portion 503 that may include a title and/or one or more of an image, an animated image file, a video clip of the item, etc. The processed keywords 278 generated in process flow 250 may be rendered by computing devices 16, 18, 20 and displayed as keywords in a second portion 505. For example, the second portion 505 may include a content container having one or more keywords (e.g., ranked keywords), such as the processed keywords 278 generated by the process flow 250. A third portion 507 of the user interface 501 includes lengthier textual description of the item. The lengthier textual description may include highlighted words, and may be part of the item data structure 252b that was provided to the first pre-trained model 256. The user interface 501 may further include an interface element package such as a banner, carousel, and/or other content elements that include items or content relevant to the ecommerce environment. The relative sizes, shapes, and positions of the first portion 503, the second portion 505, and the third portion 507 may be different from the example illustrated in FIG. 5A. Metadata from the textual description displayed in the third portion 507 may be used to generate more theme-aware and context-aware summary keywords that are displayed in the second portion 505.

FIG. 5B shows a process flow, in accordance with some embodiments. A process flow 550 begins when a first call 502 is made to a first pre-trained model, e.g., first LLM 512 to generate item-level theme recall set 514, which includes the one or more keywords 258. The first call 502 includes a first query 504 to the first LLM 512. The first query 504 includes one or more of, textual metadata 506, such as the textual information in the item data structure 252b, an extracted context 508, and an instruction template 510. As discussed in reference to FIG. 4B, reference items in the network environment (e.g., in catalog of items 158, in a database associated with the network environment, etc.) that match the item associated with the first call 502 are used to generate item-theme pair reference set 528, which includes the set of reference keywords 272. A second call 516 may be made to a second LLM 526 to obtain the item-theme pair reference set 528. The second call 516 includes a second query 518 to the second LLM 526. The second query 518 includes one or more of, textual metadata 520, such as the textual information in the reference item data structures 266, an extracted associated contexts 522 (e.g., one or more second contexts), and an instruction template 524.

A comparison module 533 (e.g., similar to the comparison module 262 described with reference to FIG. 4B) may receive a block list 530 (e.g., similar to the block list 260 described with reference to FIG. 4B) and compare the item level theme recall set 514 against the item-theme pair reference set 528 to determine if a term, or keyword, in the item level theme recall set 514 matches a term that is in item-theme pair reference set 528, and further that the term does not appear in the block list 530. In accordance with a determination that a particular term in the item level theme recall set 514 is also in the item-theme pair reference set 528, and that the particular term does not appear in block list 530, the particular term is then passed to a relevancy score generation module 532 (e.g., similar to the confidence score generation module 276a described with reference to FIG. 4B) as a shortlisted keyword.

The relevancy score generation module 532 may determine a relevance of the particular term for the first context extracted from the first query 504. In some embodiments, the relevancy of the particular term is checked using a pre-trained model 536. In some embodiments, the pre-trained model 536 is the first LLM 512 that was used to generate the item level theme recall set 514. For example, an input prompt to the first LLM 512 may include “Given the textual metadata used in the first query 504 and the particular term (e.g., which correspond to the extracted theme), how relevant is the particular term for the first context in the first query?”. The pre-trained model 536 generates, as an output 538, a confidence score that corresponds to how relevant the particular term is for the first context in the query.

In accordance with a determination that the confidence score exceeds a predetermined threshold (e.g., greater than 0.7, greater than 0.8, greater than 0.85, etc.) the particular term (e.g., a shortlisted keyword) is passed to the ranking/filtering module 540 (e.g., similar to the ranking/filtering module 276b described with reference to FIG. 4B). Any term having a confidence score that does not meet the predetermined threshold is rejected, and not passed on to any other post-processing modules.

The ranking/filtering module 540 includes a relevancy ranking module 548 that sorts and arranges (e.g., in ascending or in descending order, etc.) the keywords that exceed the predetermined threshold set for the output of the relevancy score generation module 532. The ranking/filtering module 540 may include a synonymity filter module 542 that removes themes or keywords in an input set 544 that have similar and/or overlapping meaning, or are otherwise synonyms, to yield a filtered set 546 in which the themes or keywords have substantially distinct meanings. The synonymity filter module 542 may help with achieving keyword diversification in the keywords that are presented to a user (e.g., in the content container at the second portion 505 of the user interface 501). The filtered set 546 may include keywords that are ordered (e.g., based on the output of the relevancy ranking module 548) such that an ordered set of keywords are displayed in the content container in the second portion 505 of the user interface 501. For example, the most highly ranked keyword may be presented on the leftmost side of the second portion 505, and the lowest ranked keyword may be presented on the rightmost side of the second portion 505.

FIG. 6A shows an example input and an output of a confidence score generation module, in accordance with some embodiments. A confidence score generation module 600 receives as input, textual metadata that includes an item title, such as “gaming headset,” and is used to determine a confidence score for a keyword (e.g., theme) such as “adjustable” that is generated as an output (e.g., similar to the one or more keywords 258 described with reference to FIG. 4B) from a first pretrained model that receives the textual metadata as part of an item data structure. In some embodiments, the confidence score generation module 600 serves to double-check the results generated by the first pretrained model (e.g., first pretrained model 256 described in FIG. 4B) and the reference results generated by the second pre-trained model (e.g., second pretrained model 270 described in FIG. 4B), and revalidates how relevant a particular generated theme is, with respect to an item. Using the same headset example described above, an input prompt to a pretrained model 604 to generate the confidence score may be “how relevant is “adjustable” to a given item's contextual metadata?” In some embodiments, the pretrained model 604 is the same pretrained model that generated the one or more keywords 258 described in FIG. 4B.

An output 606 from the pretrained model 604 includes a confidence score associated with the theme (e.g., “adjustable”) regarding the relevance of the theme to the first context extracted from the textual metadata associated with the item. For example, the theme “adjustable” may be associated with a confidence score of 0.9, indicating that the theme “adjustable” has a high level of relevance for a gaming headset.

FIG. 6B shows an example input and example outputs of a post-processing/evaluation module, in accordance with some embodiments. A post-processing/evaluation module 610 receives as input 612, textual metadata that includes an item title, such as “gaming_headset,” and a list of keywords, such as themes like “adjustable,” “compatible,” “durable,” and “convenient” that are generated as outputs (e.g., similar to the one or more keywords 258 described with reference to FIG. 4B) from a first pretrained model. In some embodiments, using the confidence score generation module 600, relevancy confidence scores are determined at a module 614 for each of the themes in the list of themes and ranked. For example, “convenient” has a highest relevance confidence score of 0.9, followed by “adjustable” and “durable,” each with a confidence score of 0.8, and “compatible” having a confidence score of 0.5. The ranked list of themes is sent to a uniqueness determination module 616 that sorts the list of keywords based on how generic or specific a theme is. The uniqueness determination module 616 approximates how generic or unique a theme is for a given item based on how common the theme is in a similar group of items. For example, the given item may be a headset that is newly listed by a user. The ecommerce environment may have a large list of headsets in its catalog of items 158 that are used as reference items for the newly listed headset, as described in FIG. 4B. The uniqueness determination module 616 may determine, based on the theme/keyword “convenient” being associated with, for example, 30% of the reference items (e.g., reference headsets, etc.) that the theme “convenient” is more generic than the theme “compatible,” which is for example, associated with 5% of the reference items. As another example, for a board game, the theme “collaborative” is more generic than the theme “nostalgic.” In some embodiments, the uniqueness determination module 616 helps to break a tie between two themes that have the same or similar relevancy-confidence score. The uniqueness determination module 616 may allow keywords to be selected or ranked differently for different use cases. For example, in some use cases, a lower risk tolerance level, and/or a “safer” output is preferred, while in some use cases, a more unique output may be preferred such that items may have more distinct keywords, etc. In some embodiments, a more generic keyword may be preferred over a specific keyword as the generic keyword may be more easily understood by a user browsing a user interface that displays the keywords. An output 618 from the post-processing/evaluation module 610 may include the top entries in the output of module 614 and/or the uniqueness determination module 616.

Manual generation of keywords for a variety of items in a catalog of items is burdensome and time consuming. Forgoing the use keywords may inconvenience a user of the environment, hindering their decision-making process regarding an item, and may increase the amount of time a user takes to understand the item (e.g., by reading through a lengthier textual description, instead of reviewing appropriately summarized keywords associated with the item). Keyword and interface generation systems and methods as disclosed herein significantly reduce this problem, allowing automated generation of keywords associated with an item that are context-aware, which allows a user to make a decision about the newly added item more quickly, for example, by summarizing using informative keywords why users may like the newly listed item. For example, in some embodiments described herein, a user lists a new item in the ecommerce environment by providing textual metadata and textual description of the newly listed item, and keywords that are context-aware are automatically generated for the newly listed item. For example, the ecommerce environment conducts a regular check (e.g., a daily, or every couple of days, etc.) to determine which newly listed items do not yet have associated keywords, and automatically generates keywords for those items. Beneficially, programmatically generating keywords eliminates the requirement to manually generate summary keywords that correspond to a large number of newly listed items (e.g., in the catalog of items 158, etc.), and allows generation of context-aware summary keywords without additional input from the user listing the item. The keywords may increase user engagement and enrich the user's experience (e.g., while viewing the user interface 501).

The keyword and interface generation systems and methods as disclosed herein may be scaled, using one or more LLMs, to generate and/or extract keywords for a large set of items that are optimized and theme-aware highlights even when there may be uncertainty (e.g., missing terms or fields, etc.) in the data from the catalog of items (e.g., catalog of items 158). The keyword and interface generation systems and methods as disclosed herein are able to provide theme-aware keywords by understanding relational connections in the textual description and other metadata of the item data structure 252b. The keyword and interface generation systems and methods as disclosed herein may reduce the LLM's tendencies to hallucinate (e.g., by using a reference set of keywords from a second LLM to check the output of a first LLM), making the automatically generated keywords more reliable. Generated keywords that may be synonyms for one another may be removed to increase the diversity of keywords presented to a user. Similarly, non-informative keywords may also be removed to provide a user with more pertinent and informative keywords. Inappropriate keywords may be removed to ensure user's safety. The disclosed systems and methods are adaptable and may be able to update or replace the LLM model used for automatic keyword and interface generation with minimal effort.

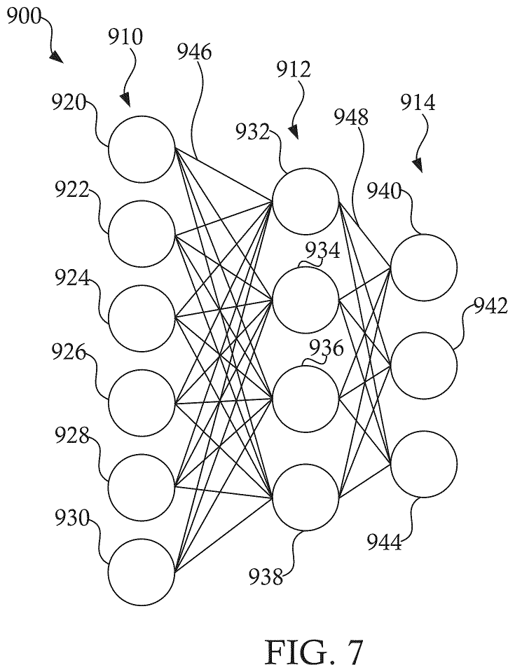

FIG. 7 illustrates an artificial neural network 900, in accordance with some embodiments. Alternative terms for “artificial neural network” are “neural network,” “artificial neural net,” “neural net,” or “trained function.” The neural network 900 comprises nodes 920-944 and edges 946-948, wherein each edge 946-948 is a directed connection from a first node 920-938 to a second node 932-944. In general, the first node 920-938 and the second node 932-944 are different nodes, although it is also possible that the first node 920-938 and the second node 932-944 are identical. For example, in FIG. 7 the edge 946 is a directed connection from the node 920 to the node 932, and the edge 948 is a directed connection from the node 932 to the node 940. An edge 946-948 from a first node 920-938 to a second node 932-944 is also denoted as “ingoing edge” for the second node 932-944 and as “outgoing edge” for the first node 920-938.

The nodes 920-944 of the neural network 900 may be arranged in layers 910-914, wherein the layers may comprise an intrinsic order introduced by the edges 946-948 between the nodes 920-944 such that edges 946-948 exist only between neighboring layers of nodes. In the illustrated embodiment, there is an input layer 910 comprising only nodes 920-930 without an incoming edge, an output layer 914 comprising only nodes 940-944 without outgoing edges, and a hidden layer 912 in-between the input layer 910 and the output layer 914. In general, the number of hidden layer 912 may be chosen arbitrarily and/or through training. The number of nodes 920-930 within the input layer 910 usually relates to the number of input values of the neural network, and the number of nodes 940-944 within the output layer 914 usually relates to the number of output values of the neural network.

In particular, a (real) number may be assigned as a value to every node 920-944 of the neural network 900. Here, xᵢ⁽ⁿ⁾ denotes the value of the i-th node 920-944 of the n-th layer 910-914. The values of the nodes 920-930 of the input layer 910 are equivalent to the input values of the neural network 900, the values of the nodes 940-944 of the output layer 914 are equivalent to the output value of the neural network 900. Furthermore, each edge 946-948 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 920-938 of the m-th layer 910, 912 and the j-th node 932-944 of the n-th layer 912, 914. Furthermore, the abbreviation w_{i,j}⁽ⁿ⁾ is defined for the weight w_{i,j}^{(n,n+1)}.

In particular, to calculate the output values of the neural network 900, the input values are propagated through the neural network. In particular, the values of the nodes 932-944 of the (n+1)-th layer 912, 914 may be calculated based on the values of the nodes 920-938 of the n-th layer 910, 912 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 910 are given by the input of the neural network 900, wherein values of the hidden layer(s) 912 may be calculated based on the values of the input layer 910 of the neural network and/or based on the values of a prior hidden layer, etc.

In order to set the values w_{i,j}^{(m,n)} for the edges, the neural network 900 has to be trained using training data. In particular, training data comprises training input data and training output data. For a training step, the neural network 900 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 900 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 914, wherein f′ is the first derivative of the activation function, and tⱼ⁽ⁿ⁺¹⁾ is the comparison training value for the j-th node of the output layer 914.

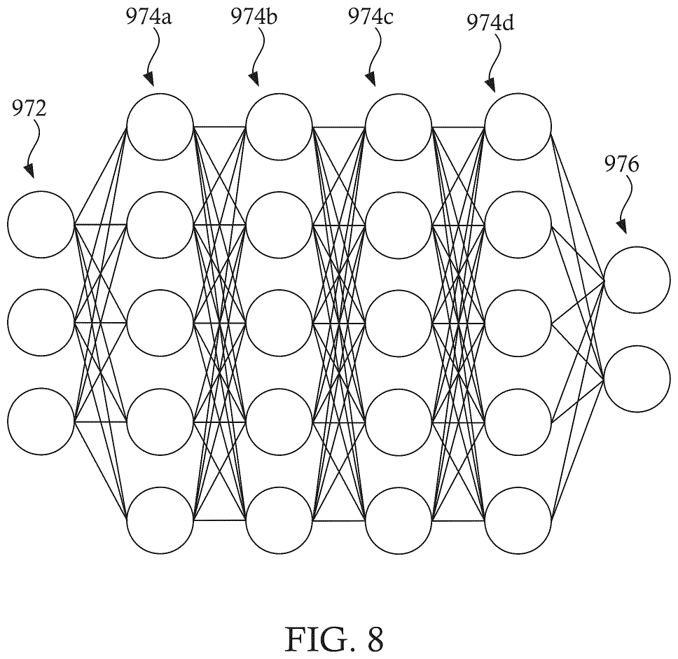

FIG. 8 illustrates a deep neural network (DNN) 970, in accordance with some embodiments. Alternative terms for “artificial neural network” are “neural network,” “artificial neural net,” “neural net,” or “trained function.” The DNN 970 is an artificial neural network, such as the neural network 900 illustrated in conjunction with FIG. 7, that includes representation learning. The DNN 970 may include an unbounded number of (e.g., two or more) intermediate layers 974a-974d each of a bounded size (e.g., having a predetermined number of nodes), providing for practical application and optimized implementation of a universal classifier. Each of the layers 974a-974d may be heterogenous. The DNN 970 may model complex, non-linear relationships. Intermediate layers, such as intermediate layer 974c, may provide compositions of features from lower layers, such as layers 974a, 974b, providing for modeling of complex data.

In some embodiments, the DNN 970 may be considered a stacked neural network including multiple layers each may execute one or more computations. The computation for a network with L hidden layers may be denoted as:

$$f ( i ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 970 is a feedforward network in which data flows from an input layer 972 to an output layer 976 without looping back through any layers. In some embodiments, the DNN 970 may include a backpropagation network in which the output of at least one hidden layer is provided, e.g., propagated, to a prior hidden layer. The DNN 970 may include any suitable neural network, such as a self-organizing neural network, a recurrent neural network, a convolutional neural network, a modular neural network, and/or any other suitable neural network.

In some embodiments, a DNN 970 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 970 may include a neural multiplicative model (NMM), including a multiplicative form for the NAM mode using a log transformation of the dependent variable y and the independent variable x:

y=e^{β}e^{f(log x)}e^{Σ}^{ᵢ}^{f}^{ᵢ}^{^{d}}^{(d}^{ᵢ}⁾

where d represents one or more features of the independent variable x.

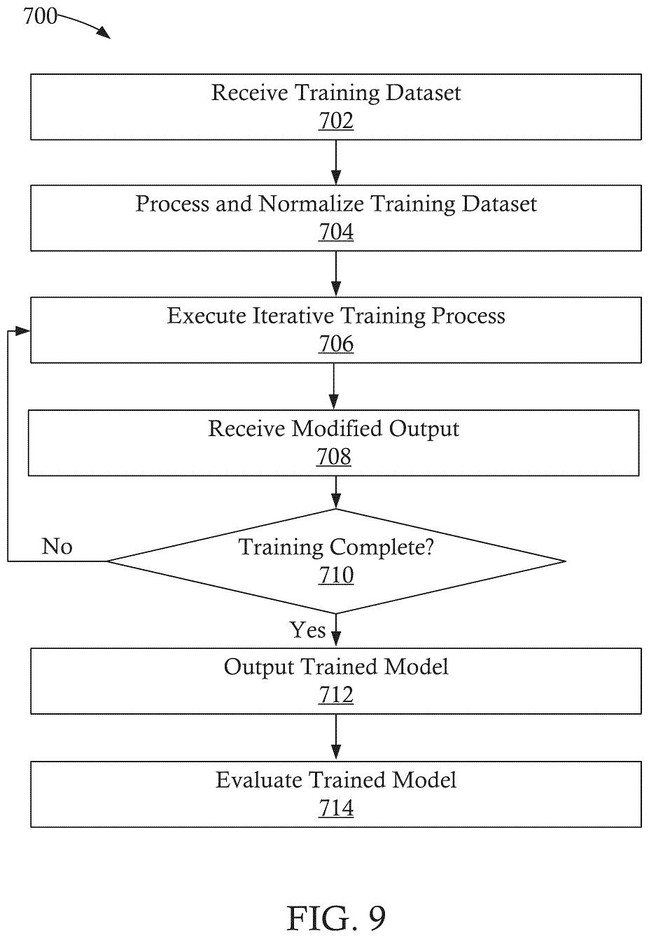

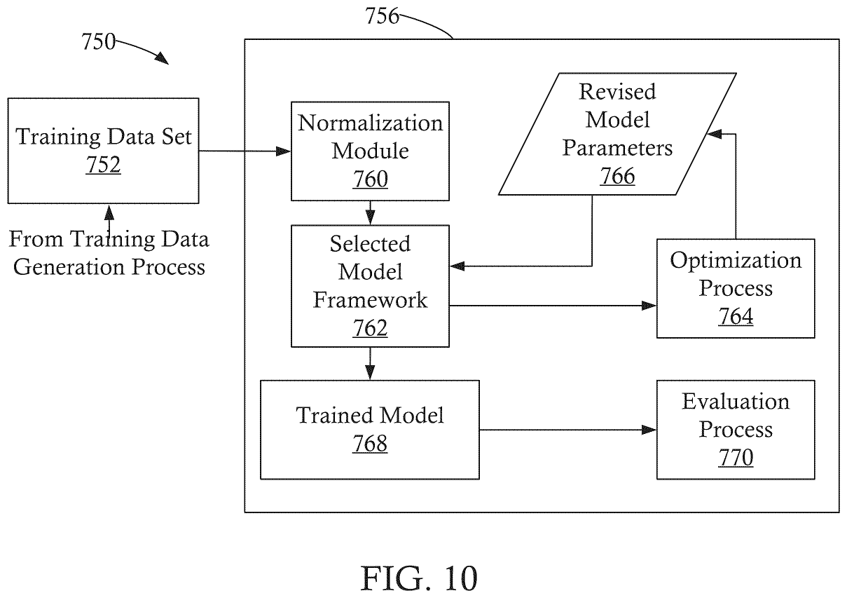

In some embodiments, one or more trained models can be generated using an iterative training process based on a training dataset. FIG. 9 illustrates a method 700 for generating a trained model, such as a trained optimization model, in accordance with some embodiments. FIG. 10 is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data.

At optional step 704, the received training dataset 752 is processed and/or normalized by a normalization module 760. For example, in some embodiments, the training dataset 752 can be augmented by imputing or estimating missing values of one or more features. In some embodiments, processing of the received training dataset 752 includes outlier detection that removes data likely to skew training of a model. In some embodiments, processing of the received training dataset 752 includes removing features that have limited value with respect to training of a relevant model.

At step 706, an iterative training process is executed to train a selected model framework 762. The selected model framework 762 can include an untrained (e.g., base) machine learning model and/or a partially or previously trained model (e.g., a prior version of a trained model). The training process iteratively adjusts parameters (e.g., hyperparameters) of the selected model framework 762 to minimize a cost value (e.g., an output of a cost function) for the selected model framework 762.

The training process is an iterative process that generates set of revised model parameters 766 during each iteration. The set of revised model parameters 766 can be generated by applying an optimization process 764 to the cost function of the selected model framework 762. The optimization process 764 can reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, is output and provided for use in one or more processes, such as a keyword generation method 100 discussed above. At optional step 712, a trained model 768 can be evaluated by an evaluation process 770. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a processor; and
a non-transitory memory, storing instructions, that when executed, cause the processor to:
receive an item data structure including textual information;
determine a first context associated with the textual information;
generate a plurality of keywords using a first trained model that receives the textual information and the first context;
receive a plurality of matching item data structures including respective textual information corresponding to a plurality of matching items associated with the item data structure;
determine one or more second contexts associated with the respective textual information;
generate a set of reference keywords using a second trained model that receives the respective textual information and one of the one or more second contexts;
determine whether the set of reference keywords includes at least one keyword in the plurality of keywords;
in accordance with a determination that the set of reference keywords includes the at least one keyword in the plurality of keywords:
determine a relevancy score between the at least one keyword in the plurality of keywords and the first context using the first trained model; and
in accordance with a determination that the relevancy score exceeds a first threshold, generate an interface that includes the at least one keyword in the plurality of keywords.

2. The system of claim 1, wherein the instructions further cause the processor to:
select a plurality of shortlisted keywords from the plurality of keywords, wherein each of the plurality of shortlisted keywords has a corresponding relevancy score that exceeds the first threshold;
sort the plurality of shortlisted keywords based on the corresponding relevancy score; and
apply a synonymity filter to remove keywords from the plurality of shortlisted keywords that have similar meaning.

3. The system of claim 2, wherein the interface includes the plurality of shortlisted keywords ranked based on the corresponding relevancy score.

4. The system of claim 1, wherein generating the at least one keyword by providing the textual information and the first context to the first trained model comprises providing a prompt to the first trained model, wherein the prompt guides the first trained model to generate an output that comprises one or more words absent from the textual information.

5. The system of claim 4, wherein the at least one keyword corresponds to a theme extracted from the first context by the first trained model based on the first context and the textual information, and wherein the theme comprises a word absent from the textual information.

6. The system of claim 5, wherein the set of reference keywords includes at least one item-theme pair.

7. The system of claim 1, wherein determining whether the set of reference keywords includes the at least one keyword comprises determining the at least one keyword is an allowed keyword.

8. A computer-implemented method, comprising:
receiving an item data structure including textual information;
determining a first context associated with the textual information;
generating a plurality of keywords using to a first trained model that receives the textual information and the first context;
receiving a plurality of matching item data structures including respective textual information corresponding to a plurality of matching items associated with the item data structure;
determining one or more second contexts associated with the respective textual information in the plurality of keywords;
generating a set of reference keywords using a second trained model that receives the respective textual information and one or more second contexts;
determining whether the set of reference keywords includes at least one keyword in the plurality of keywords; in accordance with a determination that the set of reference keywords includes the at least one keyword in the plurality of keywords:
determining a relevancy score between the at least one keyword in the plurality of keywords and the first context using the first trained model; and
in accordance with a determination that the relevancy score exceeds a first threshold, generating an interface that includes the at least one keyword in the plurality of keywords.

9. The method of claim 8, further comprising:
selecting a plurality of shortlisted keywords from the plurality of keywords, wherein each of the plurality of shortlisted keywords has a corresponding relevancy score that exceeds the first threshold;
sorting the plurality of shortlisted keywords based on the corresponding relevancy score; and
applying a synonymity filter to remove keywords from the plurality of shortlisted keywords that have similar meaning.

10. The method of claim 9, wherein the interface includes the plurality of shortlisted keywords that are ranked based on the corresponding relevancy score.

11. The method of claim 8, wherein generating the at least one keyword using the first trained model comprises providing a prompt to the first trained model, wherein the prompt guides the first trained model to generate an output that comprises one or more words absent from the textual information.

12. The method of claim 11, wherein the at least one keyword corresponds to a theme extracted from the first context by the first trained model based on the first context and the textual information, and wherein the theme comprises a word absent from the textual information.

13. The method of claim 12, wherein the set of reference keywords includes at least one item-theme pair.

14. The method of claim 8, wherein determining whether the set of reference keywords includes the at least one keyword comprises determining the at least one keyword is an allowed keyword.

15. A non-transitory computer readable medium having instructions stored thereon, wherein the instructions, when executed by at least one processor, cause at least one device to perform operations comprising:
receiving an item data structure including textual information;
determining a first context associated with the textual information;
generating a plurality of keywords using a first trained model that receives the textual information and the first context;
receiving a plurality of matching item data structures including respective textual information corresponding to a plurality of matching items associated with the item data structure;
determining one or more second contexts associated with the respective textual information;
generating a set of reference keywords using a second trained model that receives the respective textual information and one of the one or more second contexts to
determining whether the set of reference keywords includes at least one keyword in the plurality of keywords;
in accordance with a determination that the set of reference keywords includes the at least one keyword in the plurality of keywords:
determining a relevancy score between the at least one keyword in the plurality of keywords and the first context using the first trained model; and
in accordance with a determination that the relevancy score exceeds a first threshold, generating an interface that includes the at least one keyword in the plurality of keywords.

16. The non-transitory computer readable medium of claim 15, wherein the instructions further cause the processor to:
select a plurality of shortlisted keywords from the plurality of keywords, wherein each of the plurality of shortlisted keywords has a corresponding relevancy score that exceeds the first threshold;
sort the plurality of shortlisted keywords based on the corresponding relevancy score; and
apply a synonymity filter to remove keywords from the plurality of shortlisted keywords that have similar meaning.

17. The non-transitory computer readable medium of claim 16, wherein the interface includes the plurality of shortlisted keywords that are ranked based on the corresponding relevancy score.

18. The non-transitory computer readable medium of claim 15, wherein the instructions cause the processor to generate the at least one keyword by providing the textual information and the first context to the first trained model comprises providing a prompt to the first trained model, wherein the prompt guides the first trained model to generate an output that comprises one or more words absent from the textual information.

19. The non-transitory computer readable medium of claim 18, wherein the at least one keyword corresponds to a theme extracted from the first context by the first trained model based on the first context and the textual information, and wherein the theme comprises a word absent from the textual information.

20. The non-transitory computer readable medium of claim 19, wherein the set of reference keywords includes at least one item-theme pair.
